(19) United States
(12) Patent Application Publication
(10) Pub. No.: US 2021/0328866 A1
(43) Pub. Date: Oct. 21, 2021

(54) METHOD TO DEVELOP QUALITY ASSURANCE AND TESTING ENVIRONMENT USING NETWORK FUNCTION VIRTUALIZATION

(71) Applicant: Saudi Arabian Oil Company, Dhahran (SA)

(72) Inventor: Mostafa Al Amer, Dhahran (SA)

(21) Appl. No.: 16/853,264

(22) Filed: Apr. 20, 2020

(51) Int. Cl. H04L 12/24; H04L 12/46; H04L 29/12

(52) U.S. Cl. CPC H04L 41/0806; H04L 41/0846; H04L 61/2007; H04L 12/4641; H04L 41/5041

(57) ABSTRACT

A method for establishing a network testing environment and providing quality assurance using network function virtualization comprises obtaining a configuration file from a production network, delivering the configuration file to network function virtualization infrastructure, and provisioning a virtual network using virtual network functions that replicates all functions of the production network using the configuration file. A system comprises a deployed production network with plural network components, at least one of which stores a configuration file having information regarding addresses of the components and a configuration management system which obtains the configuration file from the production network. A network function virtualization infrastructure is programmed to receive the configuration file from the configuration management system and is configured to provision a virtual network using virtual network functions that replicate the functions of all of the plurality of network components in the production network using on the configuration file.

### FIELD OF THE DISCLOSURE

The present disclosure concerns a method for testing and assuring quality of production networks using network function virtualization (NFV).

### BACKGROUND OF THE DISCLOSURE

Network functions virtualization (NFV) decouples network functions from specific hardware platforms such as routers, switches, and firewalls, by “virtualizing” the functions, enabling the functions to be performed on standard IT servers. NFV defines an architecture in which network functions and applications are software implementations independent of hardware. Currently-deployed enterprise systems often include older hardware network devices and platforms. These devices and platforms are often deployed with redundancy and do not always make use of the advantages enabled by new NFV systems.

### SUMMARY OF THE DISCLOSURE

The present disclosure provides a method for establishing a network testing environment and providing quality assurance using network function virtualization. The method comprises obtaining a configuration file from a production network, delivering the configuration file to network function virtualization infrastructure, and provisioning a virtual network using virtual network functions that replicates all functions of the production network using the configuration file.

In some embodiments, the method further comprises modifying a routing table, system parameters and addressing assignment of the configuration file prior to delivering the configuration file to the network function virtualization infrastructure.

In certain implementations, the steps of obtaining the configuration file from the production network and delivering the configuration file to the network function virtualization infrastructure are performed using a configuration management system (CMS).

Alternatively, the steps of obtaining the configuration file from the production network and delivering the configuration file to the network function virtualization infrastructure are initiated by an administrator.

The present disclosure also provides a system for testing a network environment and for providing quality assurance using network function virtualization. The system comprises a deployed production network having a plurality of network components, at least one of the plurality of network components storing a configuration file having information regarding addresses of the components, a configuration management system coupled to the deployed production network and configured to obtain the configuration file from the production network, and network function virtualization infrastructure coupled to the configuration management system and programmed to receive the configuration file therefrom, the network function virtualization infrastructure being configured to provision a virtual network using virtual network functions that replicate the functions of all of the plurality of network components in the production network using on the configuration file.

In some embodiments, the configuration file contains a routing table having current IP addresses of the plurality of components in the production network. In certain implementations, the configuration management system is configured to modify the routing table of the configuration file.

These and other aspects, features, and advantages can be appreciated from the following description of certain embodiments of the invention and the accompanying drawing figures and claims.

### BRIEF DESCRIPTION OF THE DRAWINGS

FIG. 1 is a schematic diagram that illustrates a system for providing a network testing environment and providing quality assurance by network function virtualization according to an embodiment of the present disclosure.

FIG. 2A is a schematic illustration of an aspect of an embodiment of the disclosed method for establishing a network testing environment NFV in which a network administrator pulls configuration files from the production network.

FIG. 2B is a schematic illustration of an aspect of an embodiment of the disclosed method in which configuration files are pushed to multiple virtual instances to replicate the production network.

FIG. 3 is a flow chart of an embodiment of a method of establishing a network testing environment and providing quality assurance using network function virtualization according to an embodiment of the present disclosure.

FIG. 4A is a schematic illustration shown communication traffic that normally is routed along a first path between the network cloud (e.g.: Internal, External, Internet) and the production network being routed along a backup path between the network cloud and the virtual network.

FIG. 4B is a schematic illustration of an aspect of an embodiment of the disclosed method, in which the NFVI server replicates the production network configuration in the virtual network to conduct testing and validation.

### DETAILED DESCRIPTION OF CERTAIN EMBODIMENTS OF THE DISCLOSURE

Disclosed herein is a method of establishing a network testing environment and providing quality assurance by replicating a production network in a network function virtualization (NFV) platform. According to embodiments of the method, configuration files including system parameters, IP addresses and routing tables for components of a production network are obtained, the configuration files are pushed to virtual infrastructure resources in a NFV platform, and the virtual infrastructure resources are then provisioned using NFV.

The configuration files can be pulled from the production network and pushed to the NFV platform automatically using a configuration management system (CMS). The CMS can access data in the production network components. In some implementations, the CMS can access the production network components and obtain configuration files using ssh (a secure socket shell). In some embodiments, the configuration files can be pulled from the production network and pushed to the NFV platform manually.

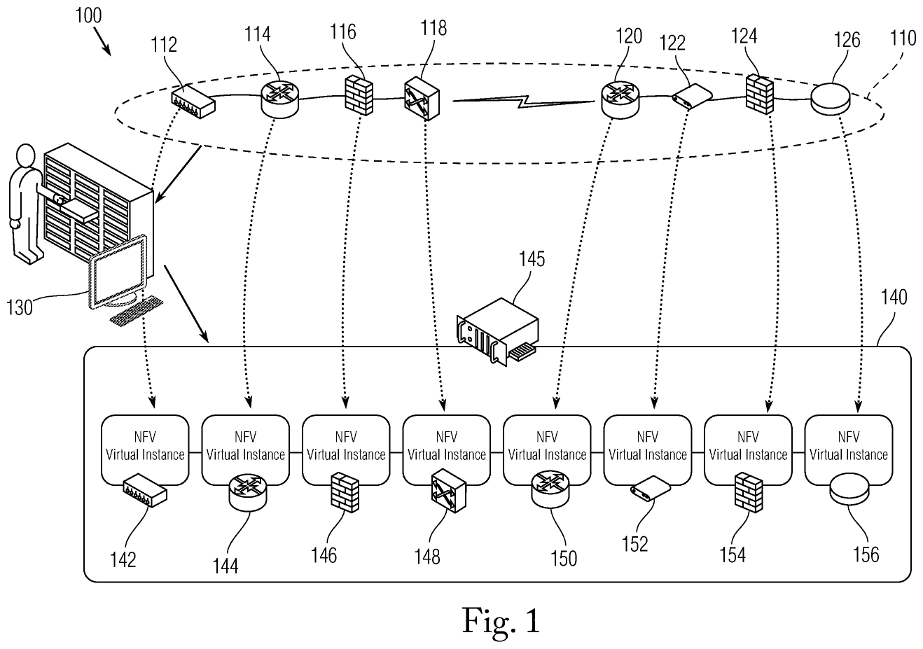

FIG. 1 is a schematic diagram that illustrates a system for providing a network testing environment and providing quality assurance by network function virtualization according to an embodiment of the present disclosure. The main components of system 100 include a production network 110 including hardware network devices, a configuration management system 130, and a virtual network 140 based on NFV. The production network 110 can include any number of components and component types arranged in any topology. For ease of illustration a linear network including several network components 112, 114, 116, 120, 122, 124, 126 is shown. The components 112-126 can comprise router, switch, security solutions (such as Firewalls and Intrusion Prevention System—IPS) gateways, any other discrete components and combinations of such components. Generally, components 112-126 are dedicated to specific networking tasks, and include hardware, firmware and/or software specifically designed for such tasks. One or more components 112-126 of the production network store configuration information in one or more files. The configuration files can include system parameters, routing (IP address assignments) and host information for all interfaces in the network.

The production network 110 is overseen by an IT network administrator (not shown) and receives configuration information from a configuration management system (CMS) 130, which executes tasks automatically but also can receive input from the IT administrator. The configuration is typically stored in files that define functional settings and parameters. The information in the configuration files can be used by the operating system for intended functionality. For example, a Firewall relies upon a configuration file for IP addressing, applications, and policies to allow and/or deny traffic.

The CMS 130 is a computer system that, among other functions, is programmed to pull or actively obtain the most current configuration files from the interfaces in the production network. In some implementations, the CMS uses a secure socket shell (ssh) to access the components of the production network 110 and to obtain the live configuration files. In some implementations, the CMS 130 is programmed to automatically modify the management address assignments in the routing table of the network systems in the configuration file so that the Network admin can access (administrate) the production devices as well as the NFV-based devices (that have similar setup) at the same time without creating any duplications.

Alternatively, the configuration files can be pulled obtained and modified by administrative personnel having secure access to the production network. In embodiments that employ a CMS, the CMS 130 is programmed with the task of using the configuration file of the production network to provision the virtual network 140. To do so, it “pushes” or sends the modified configuration files to network functions virtualization infrastructure server (NFVI) 145 which includes the hardware and software components that comprise the environment in which virtual network functions (VNFs) are deployed. For simple networks, the NFVI can be implemented using a general-purpose computing device with an x86 processor, as an example.

The NFVI 145 uses the configuration files to provision a virtual replication of the production network in which each component is mirrored by a virtual instance of network function virtualization. In the example depicted in FIG. 1, the components of production network 112, 114, 116, 118, 120, 122, 124, and 126 are each virtually replicated as corresponding NFV instances 142, 144, 146, 148, 150, 152, 154 and 156 in virtual network 140. It is again noted that NFV instances 142-156 are implemented using software executed on single processors (as depicted) or multiple connected processors co-located in a single device are remotely connected. The virtual network 140 can perform all of the networking functions of the production network including, but not limited to, router, switch, security solutions (such as Firewalls and Intrusion Prevention System—IPS), and gateway functions and operations.

Virtual network 140, by replicating all of the functions and configurations of the production network, provides a testing environment for testing new network features or patches without the need to test the features or patches in the production network, which would necessitate brining the production network offline and could cause complications if there is a problem during testing. Similarly, virtual network 140 enables quality assurance procedures that are used to verify network changes before moving to production. Additionally, virtual network provides business continuity redundancy in cases in which high-availability is required to mimic the production network. Network function virtualization of the production network also aids network administrators address the production network failures rapidly with minimal cost. In certain implementations, the NFVI server 145 executes one or more programs for network virtualization management and orchestration (M&O). NFV M&O is used in such implementations to direct cycle management of physical and software resources and to interact with other systems such as an operation support and business support systems that can be deployed outside the NFV.

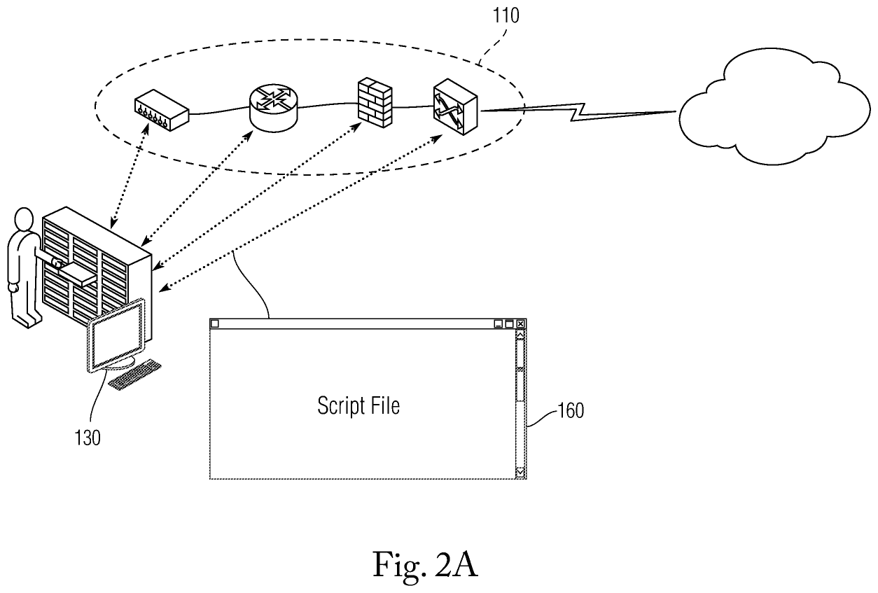

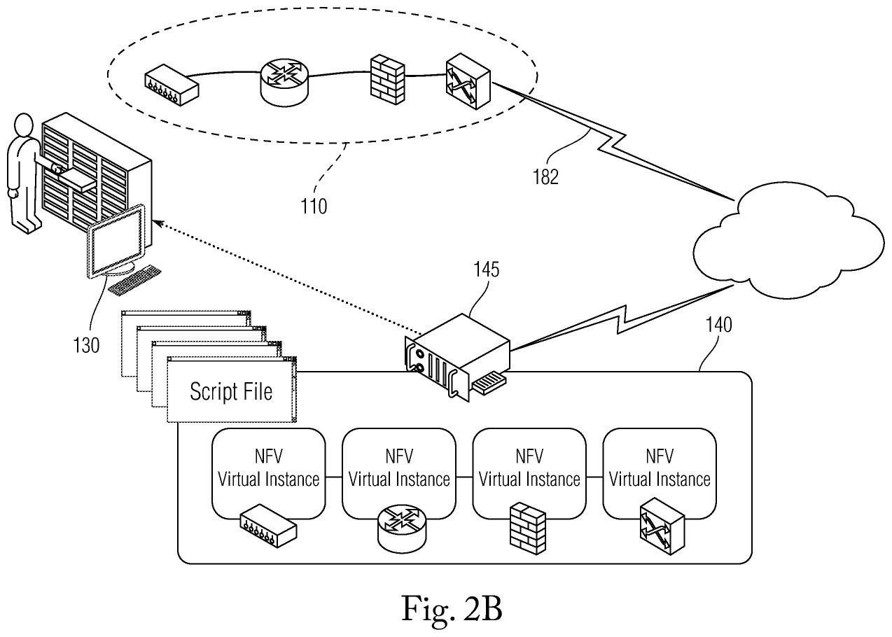

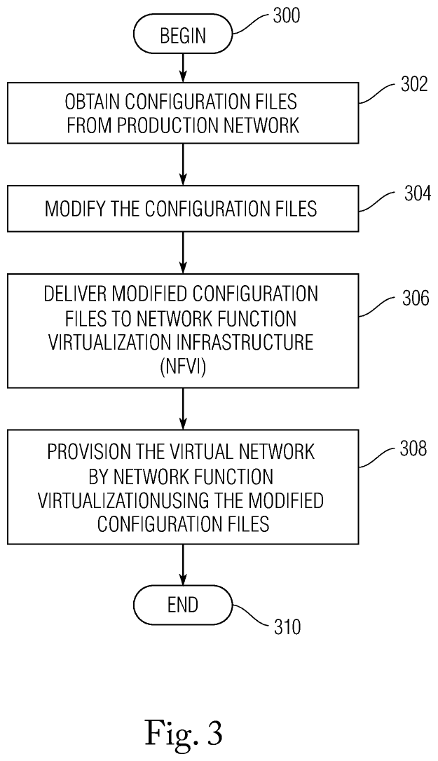

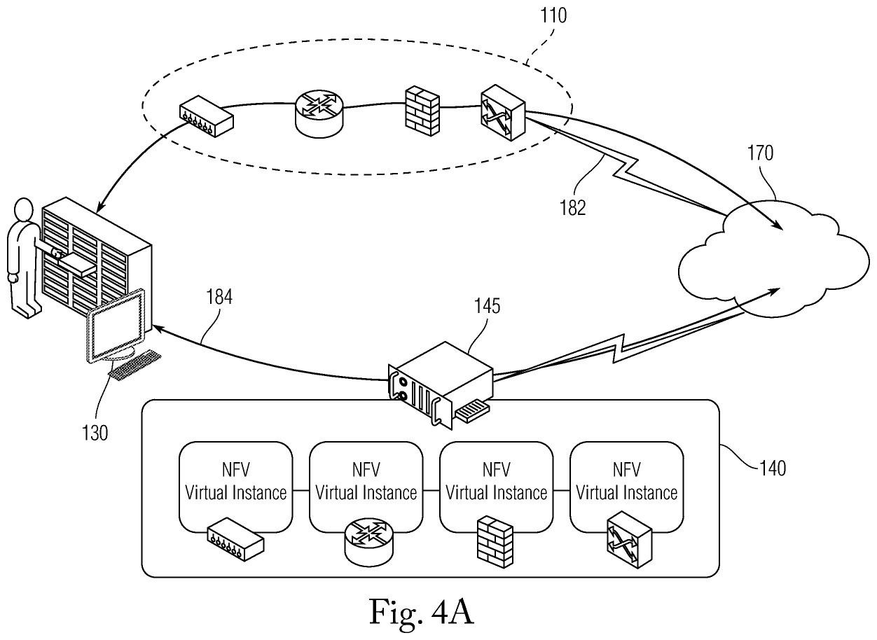

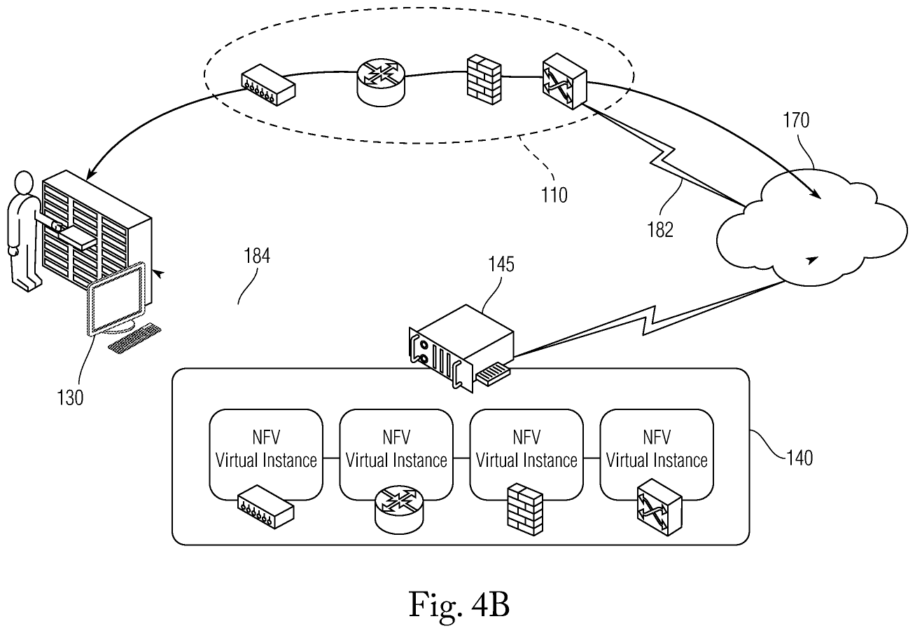

An exemplary method of establishing a network testing environment and providing quality assurance using network function virtualization is shown in a flow chart in FIG. 3. Aspects of the method are also illustrated in the schematic arrangements of the embodiments shown in FIGS. 2A, 2B, 4A and 4B. Returning to FIG. 3 in step 300, the method begins. As shown in FIG. 2A, in a first step (302), the CMS 130 uses the configuration management system 130 to access the devices in the production network 110 and pulls configuration files 160 from the devices. Accessing the devices and pulling the configuration files from each is done through conventional communication exchange. In an optional following step (304), information in the configuration files, including routing tables (address data) can be modified. Modification can be, for instance, by replacing functional setting data or other parameters within the file, by writing new information to the file, or by including additional information in the file such as information relating to this pulling and accessing event. In step (306), illustrated in FIG. 2B, the CMS 130 accesses the NFVI server 145 and delivers the configuration files to the network function virtualization infrastructure (NFVI) in support of multiple virtual instances to replicate the production network set-up. In step 308, the NFVI uses the modified configuration file to provision the virtual network 140 using network function virtualization for testing and quality assurance. By provisioning the virtual network, a virtual instance is enabled separate from the production network such that the testing and quality assurance is being performed on this separate network. The method ends in step (310).

One of the applications of the virtual network 140 is to provide redundancy in case of an interruption or malfunction in the production network 110. In the illustration of FIG. 4A, incoming and outgoing communication traffic that normally is routed along a first path 182 between the network cloud (Internal/External network) 170 and the production network is routable along a second path 184 between the cloud and the virtual network 140.

FIG. 4B is a schematic illustration of step 308, in which the NFVI server 145 replicates the production network configuration in the virtual network 140 to conduct testing and validation. For example, the virtual network 140 can be used to test new software patches, security and operational features, operating system (OS) upgrades to routing equipment, etc.

The replication of the production network 110 in the virtual network creates a quality assurance environment. The virtual network environment provides for end-to-end functional and coverage testing during deployment and subsequently during orchestration. Testing for benchmark performance levels can be performed on different hardware and middleware platforms, and different use-complexity levels single user/multi-tenant) can be assessed using the systems and methods disclosed herein.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the scope of the invention encompassed by the present disclosure, which is defined by the set of recitations in the following claims and by structures and functions or steps which are equivalent to these recitations.

1. A method for establishing a network testing environment and providing quality assurance using network function virtualization, comprising:
obtaining a configuration file from a production network;
delivering the configuration file to network function virtualization infrastructure; and
provisioning a virtual network using virtual network functions that replicate all functions of the production network using the configuration file; and
testing for benchmark performance levels of the virtual network on one or more hardware platforms and one or more middleware platforms.

2. The method as in claim 1, further comprising modifying the configuration file prior to delivering the configuration file to the network function virtualization infrastructure.

3. The method as in claim 2, wherein the steps of obtaining the configuration file from the production network and delivering the configuration file to the network function virtualization infrastructure are performed using a configuration management system (CMS).

4. The method as in claim 2, wherein the steps of obtaining the configuration file from the production network and delivering the configuration file to the network function virtualization infrastructure are initiated by an administrator.

5. A system for testing a network environment and for providing quality assurance using network function virtualization comprising:
a deployed production network having a plurality of network components, at least one of the plurality of network components storing a configuration file having information regarding addresses of the components;
a configuration management system coupled to the deployed production network and configured to obtain the configuration file from the production network; and
network function virtualization infrastructure coupled to the configuration management system and programmed to receive the configuration file therefrom, the network function virtualization infrastructure being configured to provision a virtual network using virtual network functions that replicate the functions of all of the plurality of network components in the production network using on the configuration file and to test for benchmark performance levels of the virtual network on one or more hardware platforms and one or more middleware platforms.

6. The system of claim 5, wherein the configuration file contains a routing table having current IP addresses of the plurality of components in the production network.

7. The system of claim 6, wherein the configuration management system is configured to modify the routing table, system parameters, and addressing assignment of the configuration file.
